(19) United States
(12) Patent Application Publication
(10) Pub. No.: US 2014/0210277 A1
(43) Pub. Date: Jul. 31, 2014

(54) INDUCTIVE POWER TRANSMISSION

(71) Applicant: POWERMAT TECHNOLOGIES LTD., Neve Ilan (IL)

(72) Inventor: Amir BEN-SHALOM, Modiin (IL)

(73) Assignee: POWERMAT TECHNOLOGIES LTD., Neve Ilan (IL)

(21) Appl. No.: 14/229,163

(22) Filed: Mar. 28, 2014

Related U.S. Application Data
(63) Continuation of application No. PCT/IL2012/050398, filed on Sep. 27, 2012.
(60) Provisional application No. 61/541,199, filed on Sep. 30, 2011.

(51) Int. Cl. H02J 17/00

(52) U.S. Cl. CPC H02J 17/00
USPC 307/104

(57) ABSTRACT

An inductive power transfer system comprising a primary inductor wired to a transmission controller and a power supply via a driver, and operable to inductively couple with a secondary inductor wired to an electric load via a reception circuit. The transmission controller instructs the driver to apply an oscillating driving voltage to said primary inductor in an intermittent pattern comprising an alternation of the driver being in an ON state and an OFF state, characterized by a transmission requirement profile. The level of power transmission during the ON state may be the power level at which the inductive power transfer system transfers power with high efficiency. The reception circuit may comprise a power storage element configured to store power received by said secondary inductor when said driving voltage is applied, and to provide power to said electric load.

### CROSS-REFERENCE TO RELATED APPLICATIONS

This application is a continuation of PCT/IL2012/050398 filed Sep. 27, 2012, which claims the benefit of U.S. Provisional Applications 61/541,199 filed Sep. 30, 2011, the disclosure of which is hereby incorporated by reference in their entirety.

### TECHNICAL FIELD

The present disclosure is directed to inductive electrical power transfer. More specifically, the disclosure relates to the efficient provision of power to electrical loads wirelessly via inductive power receivers.

### BACKGROUND

Inductive power coupling, as known in the art, allows energy to be transferred from a power supply to an electric load without connecting wires. A power supply is wired to a primary coil and an oscillating electric potential is applied across the primary coil, thereby inducing an oscillating magnetic field. The oscillating magnetic field may induce an oscillating electrical current in a secondary coil placed close to the primary coil. In this way, electrical energy may be transmitted from the primary coil to the secondary coil by electromagnetic induction without the two coils being conductively connected. When electrical energy is transferred from a primary coil to a secondary coil the coil pair are said to be inductively coupled. An electric load wired in series with such a secondary coil may draw energy from the power source wired to the primary coil when the secondary coil is inductively coupled thereto.

Induction type power outlets may be preferred to the more common conductive power sockets because they provide seamless power transmission and minimize the need for trailing wires.

The efficiency of inductive power transfer systems may vary depending upon the level of operating power. Accordingly, systems may be configured to maximize inductive power transfer efficiency at specific power levels, although, when operating at a different power levels the system may generate higher power losses. Where the expected power level required is known, a system may be configured such that power transfer efficiency is greatest for the known expected power transfer level. However, where the expected power level required is not known, or is expected to vary, it may not be possible to maximize inductive power transfer efficiency for multiple power levels. Consequently, higher energy losses may be incurred in inductive power transfer systems operable at multiple levels than in inductive power transfer systems configured to operate at predefined levels.

The need remains therefore for a practical inductive power transfer system for wirelessly delivering power in an energy efficient manner at various power levels. The present disclosure addresses this need.

### SUMMARY

In one aspect of the disclosure, there is provided an inductive power transfer system comprising a primary inductor wired to a transmission controller and a power supply via a driver, and operable to inductively couple with a secondary inductor wired to an electric load via a reception circuit, wherein: said transmission controller instructs the driver to apply an oscillating driving voltage to said primary inductor in an intermittent pattern comprising an alternation of the driver being in an ON state and an OFF state, characterized by a transmission requirement profile; and said reception circuit comprises at least one power storage element configured: to store power received by said secondary inductor when said driving voltage is applied; and to provide power to said electric load.

In certain embodiments, the level of power transmission during the ON state is constant. Optionally, the level of power transmission during the ON state is at full power.

In certain embodiments, the transmission profile is determined in accordance with a power requirement profile. Optionally, the power requirement profile is determined according to the power requirement of the electric load. Optionally, the power requirement profile is determined further based on the power requirement of the power storage element. Optionally, the transmission profile is selected from a pre-set list. Optionally, the power requirement profile is selected from a pre-set list.

In certain embodiments, the reception circuit further comprises a switching mechanism configured to direct a first portion of the power received by the secondary inductor to the electric load and to direct a second portion of the power received by the secondary inductor to the power storage element 332. Optionally, the first portion of the power received by the secondary inductor and the second portion of the power received by the secondary inductor is based on the power requirement of the electrical load. Optionally, the switching mechanism is further operable to connect said power storage element to said electric load, such that power is transferred from the power storage element to the electric load. Optionally, the switching mechanism is operable to connect said power storage element to said electric load when the driver in is the OFF state. Optionally, the switching element is operable to provide a constant level of power to the electric load despite the alternation of the driver between the ON state and the OFF state.

In certain embodiments, the power storage element comprises a capacitor.

In certain embodiments, the power storage element comprises an electrochemical cell.

In another aspect of the disclosure, there is provided a method for providing inductive power from an electric load via a primary inductor wired to a transmission controller and a secondary inductor wired to the electric load, the method comprising: providing a power storage element selectably connectable to said secondary inductor and the electrical load; determining a transmission profile having ON states and OFF states of duration selected to provide power at a required rate; driving said primary inductor at full power during the ON states as according to said transmission profile; storing, in the power storage element, excess power delivered during the ON states; and delivering power from the power storage element to said load during the OFF states.

In certain embodiments, the transmission profile is determined based on a power requirement profile. Optionally, the power requirement profile is determined based on the power requirement of the electrical load. Optionally, the power requirement profile is determined further based on the power requirement of the power storage element. In certain embodiments, the transmission profile is selected from a pre-set list. In certain embodiments, the power requirement profile is selected from a pre-set list.

Optionally, the level of power transmission during the ON state is selected such that the inductive power transfer system transfers power with a high efficiency. Indeed, the inductive power transfer may be configured to have a power transfer efficiency peak at the power level at which the system operates during the ON state.

### BRIEF DESCRIPTION OF THE DRAWINGS

For a better understanding of the disclosure and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present disclosure only, and are presented in the cause of providing what is believed to be the most useful and readily understood description of the principles and conceptual aspects of the disclosure. In this regard, no attempt is made to show structural details of the disclosure in more detail than is necessary for a fundamental understanding of the disclosure; the description taken with the drawings making apparent to those skilled in the art how the several forms of the disclosure may be embodied in practice. In the accompanying drawings:

FIG. 1A is a schematic diagram representing an inductive power transfer system according to an exemplary embodiment of the present disclosure;

FIG. 1B is a schematic diagram representing an inductive power receiver for use in the inductive power transfer system of FIG. 1A;

FIG. 2 is a block diagram representing selected components of an inductive power transfer system incorporating a transmission controller, a reception circuit and an electrical storage element according to another embodiment of the present disclosure;

FIG. 3A-C are graphs showing possible transmission profiles for the intermittent supply of power from the primary inductor coil

FIG. 4A is a block diagram showing the transfer of power from the inductive power unit to the electrical load and the power storage element;

FIG. 4B is a block diagram showing the transfer of power from the power storage element to the electrical load;

FIG. 5A is a block diagram representing selected components of the inductive power transfer signal transfer system including further components for communication between the transmission controller, the reception circuit, the electrical load and the power storage element;

FIG. 5B is an alternative block diagram representing selected components of the inductive power transfer signal transfer system including further components for communication between the transmission controller, the reception circuit, the electrical load and the power storage element; and

FIG. 6 is a flow chart representing selected steps of one possible method for transferring power to the electrical load using an intermittent power supply.

### DETAILED DESCRIPTION

Detailed embodiments are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the embodiments.

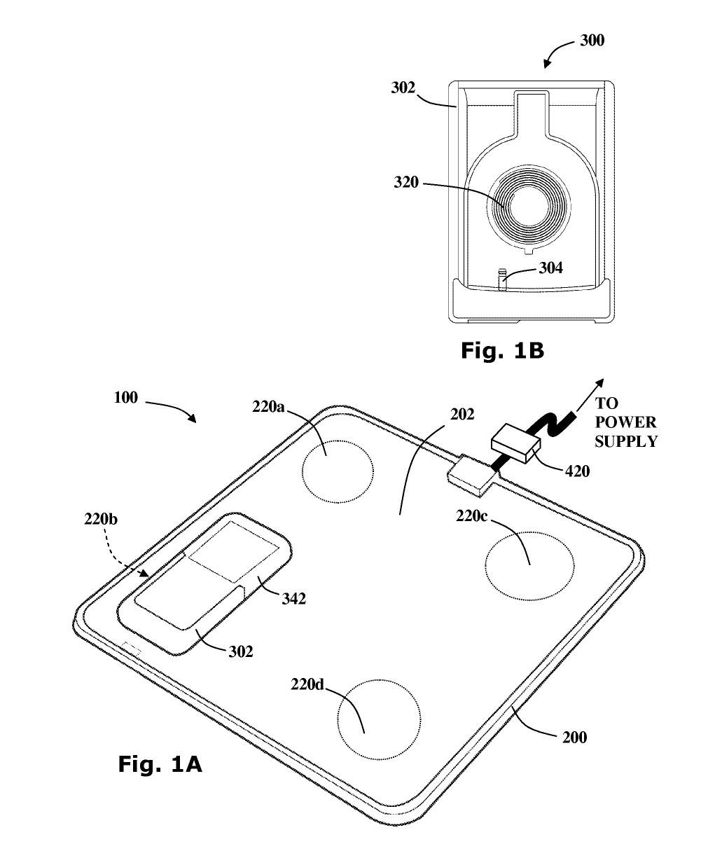

Reference is now made to FIGS. 1A and 1B showing an inductive power outlet 200 and an inductive power receiver 300 for use in an exemplary inductive power transfer system 100 according to an embodiment of the disclosure.

The inductive power outlet 200 consists of a plurality of primary inductors, e.g., four primary inductors 220a-d, incorporated within a platform 202. The inductive power receiver 300 includes a secondary inductor 320 incorporated within a case 302 for accommodating a mobile telephone 342. When a mobile telephone 342 is placed within the case 302 a power connector 304 electrically connects the secondary inductor 320 with the mobile telephone 342. As shown in FIG. 1A, the inductive power receiver 300 may be placed upon the platform 202 in alignment with one of the primary inductors 220b so that the secondary inductor 320 inductively couples with the primary inductor 220b.

The inductive power outlet 200 includes a primary inductor 220, wired to a power supply 240 via a driver 230. The driver 230 typically includes electronic components, such as a switching unit for example, for providing an oscillating electrical potential to the primary inductor 220. The oscillating electrical potential across the primary inductor 220 produces an oscillating magnetic field in its vicinity.

The inductive power receiver 300 includes a secondary inductor 320 wired to an electric load 340, typically via a reception circuit 330. The secondary inductor 320 is configured such that, when placed in the oscillating magnetic field of an active primary inductor 220, a secondary voltage is induced across the secondary inductor 320. The secondary voltage may be used to power the electric load 340.

In contradistinction to prior art inductive power transfer systems, where power is continually supplied by a driver to an electrical load at a variety of power levels, embodiments of the current disclosure may be configured to operate at constant power, albeit intermittently. Accordingly, an inductive power transfer system may be configured to run efficiently at full power, and to moderate the level of power provided by adjusting the rate at which the power supplied to the primary inductor is switched on and off. To enable this adjustment, additional elements may be included in the system for improving the efficient use of power.

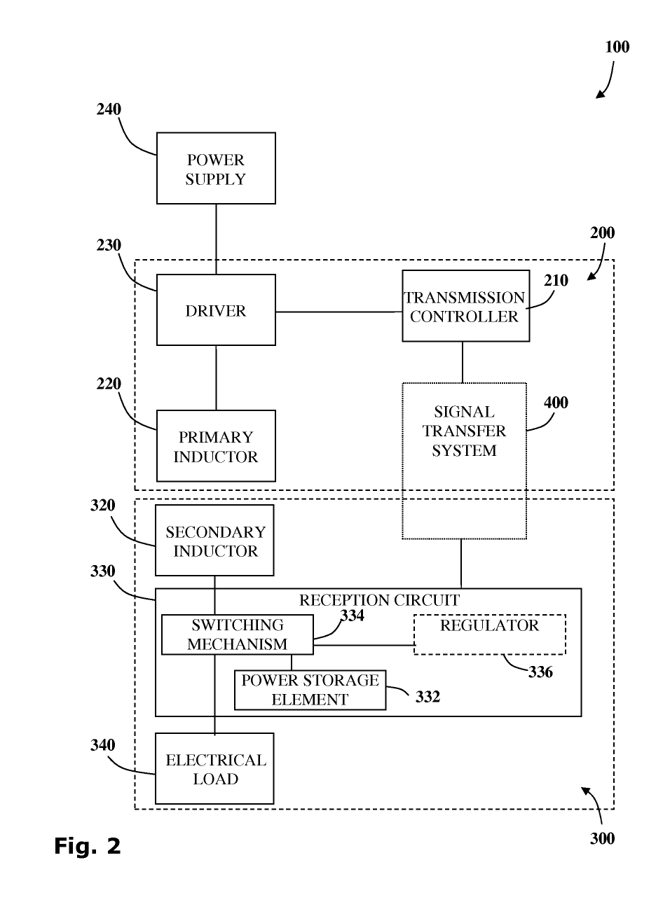

Referring now to the block diagram of FIG. 2, selected elements are shown of an inductive power transfer system 100, comprising at least one of an inductive power outlet 200 configured to provide power to a inductive power receiver 300 and at least one of an inductive power receiver 300 configured to receive power from an inductive power outlet 200. The inductive power outlet 200 includes a primary inductor 220 wired to a power source 240 via a driver 230. The driver 230 is configured to provide an oscillating driving voltage to the primary inductive coil 220. The primary inductor 220 is configured to inductively couple with a secondary inductor 320 associated with the inductive power receiver 300.

The secondary power receiver 300 includes the secondary inductor 320 wired to an electric load 340. The secondary inductor 320 is configured to inductively couple with the primary inductor 220, such that when the secondary inductor 320 and the primary inductor 220 are inductively coupled, the electric load 340 may draw power from the power source 240.

The power transfer system 100 may further include a transmission controller 210 possibly associated with the inductive power outlet 200 and a reception circuit 330 possibly associated with the inductive power receiver 300.

The transmission controller 210 may be wired to the driver 230 and may be provided to control intermittent or periodic delivery of power to the inductive power receiver 300 through, for example, controlling the intermittent or periodic delivery of the oscillating voltage by the driver 230 to the primary inductor 220.

The electrical load 340 may be connected to the secondary inductor 320 via a reception circuit 330. The reception circuit 330 may include a power storage element 332, as well as a switching mechanism 334, which may be provided to regulate power delivery to the electrical load 340, the power storage element 332 and combinations thereof.

Optionally, a signal transfer system 400 may provide a communication channel between the inductive power outlet 200 and the inductive power receiver 300. The signal transfer system 400 may enable the transfer of data between one or more of the components associated with the inductive power outlet 200 (e.g., the transmission controller 210, the primary inductor 220 and the driver 230) and one or more of the components associated with the inductive power receiver (e.g., the secondary inductor 320, the electrical load 340, the reception circuit 330, the power storage element 332, the switching mechanisms 334, the regulator 336). In a particular embodiment, the signal transfer system may enable the transfer of data between the transmission controller 210 and the reception circuit 330. The signal transfer system 400 may comprise a coil-to-coil signal transfer system operable to transfer data or instructions between the secondary inductor and the primary inductor. Alternatively or additionally the signal transfer system 400 may utilize various methods or protocols such as Bluetooth, Zigbee, WiFi, infra-red communication, audio signal transfer, or the like as well as combinations thereof.

It is noted that inductive power transfer system 100 of the disclosure may be configured to maximize inductive power transfer efficiency at a particular power level, for example at full power. Accordingly, where appropriate, the transmission controller 210 may be controlled by a transmission profile for providing an intermittent power supply, which may be characterized by a sequence or pattern of toggling the driver 230 between an ON state, in which the inductive power outlet operates at a selected efficient power level, and an OFF state, in which no power is transferred (e.g., by disconnecting the primary inductor 220 from the driver 230).

The transmission profile may be adjusted for the purpose of, e.g., adjusting the aggregate level of power supplied to the inductive power outlet 200 to the inductive power receiver 300, while the level of power supplied during the ON state is constant. The aggregate level of power supplied to the inductive power receiver may be determined by, e.g., the power requirement profile and/or the power requirement of power storage element 334 and the electrical load 340. Accordingly, the reception circuit 330 may be configured to determine the power requirements of the power storage element 332 and the electrical load 340; to provide power to the power storage element 332 and to the electrical load 340, according to their power requirements; and to provide a signal to the transmission controller 210 to control the supply of power to the inductive power receiver 300.

Optionally, the level of power transmission during the ON state is selected such that the inductive power transfer system transfers power with a high efficiency. Indeed, the inductive power transfer may be configured to have a power transfer efficiency peak at the power level at which the system operates during the ON state.

Accordingly, although the inductive power outlet always operates at the most efficient power level, nevertheless power may be transferred inductively to the electric load at a variety of power levels.

### Transmission Profile

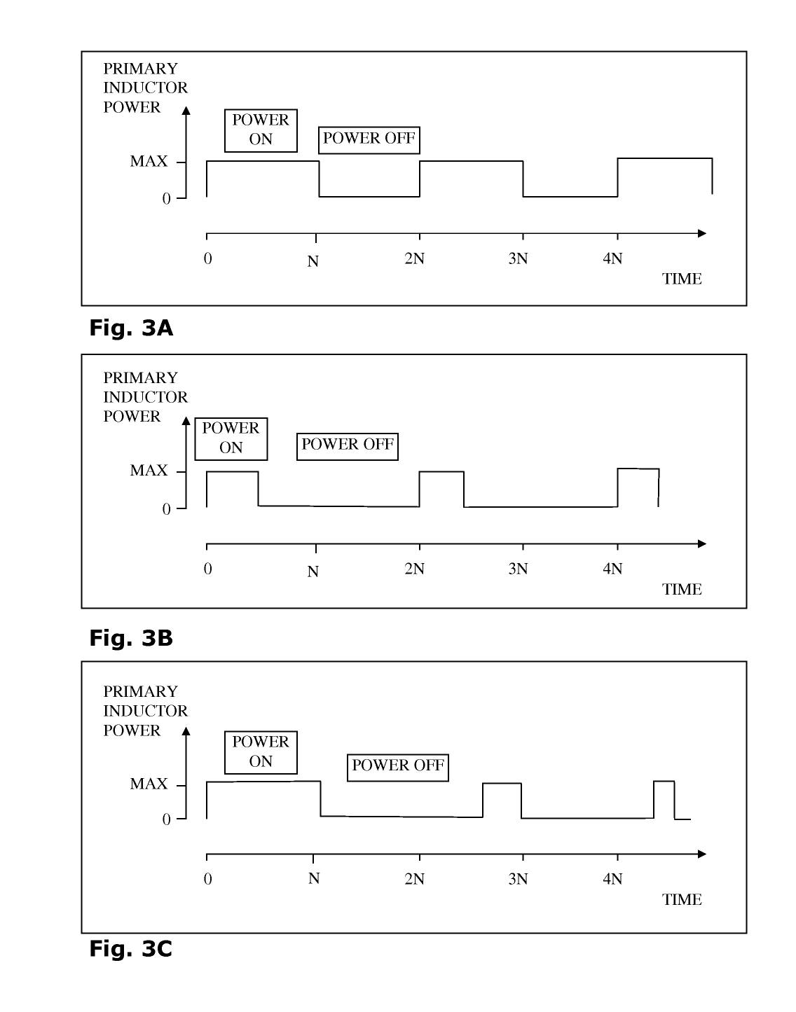

As discussed above, the transmission profile may be used to control the power level transmitted by the inductive outlet 200 to the inductive power receiver 300. The transmission profile may regulate the aggregate duration of power transfer over a period of time from the power supply 240 to the electrical load 340 (e.g., from the primary inductor 220, to the secondary inductor 320), by regulating the timing of the switching between and ON and OFF states of the driver 230. The transmission profile may be dynamically tuned by the transmission controller 210 based on, e.g., the power requirements of the electrical load 340 and/or the power storage element 332, which may be communicated to the transmission controller 210 through the signal transfer system 400. With reference to the graphs of FIGS. 3A-C, various examples are shown of possible duration times for the ON and OFF states of the driver 230.

With particular reference now to the graph of FIG. 3A, an intermittent power supply may have regular periodicity, where the ON and OFF states are equivalent in duration. By means of example, this transmission profile may be suitable for powering and charging a device that requires power at half of full power, possibly at a constant rate.

Referring now to the graph of FIG. 3B depicts the transmission profile of an intermittent power supply with regular periodicity, where duration of the OFF state is longer than duration of the ON state. By means of example, this transmission profile may be suitable for powering and charging a device that requires power at less than half of full power.

Particular reference is made to the transmission profile represented by the graph of FIG. 3C. The power profile shown in FIG. 3C is not periodic with the intermittent power supply having progressively decreasing pulse duration. Such a profile may be used, for example, where the power requirement of the electric load 340 changes over time, e.g., the electric load 340 may be (or connected to) an electric device with varying energy requirements depending on its use; or the electrical load 340 may be a battery nearing a fully charged state and thus may require progressively shorter pulses of power transfer.

For example, the transmission profile may be dynamically calculated by the transmission controller 210 according to a power requirement function, for example based upon factors such as the power requirements of the electrical load 340, which may be communicated to the transmission controller 210 through the signal transfer system 400. Additionally, the transmission profile may further be based on the power requirement of the power storage element 332.

As an example, the system 100 may use a microprocessor and an algorithm to determine a transmission profile based on a power requirement profile or the power requirements of the electric load 340 and/or the power storage element 332. Where appropriate, the transmission profile may be selected from a pre-set list of possible transmission profiles stored in computer memory.

Other transmission profiles with various periodic and non-periodic patterns the driver 230's ON state and OFF state are envisioned.

The examples of transmission profiles described hereinabove are provided for illustrative purposes only and should not be considered limiting. Other profiles may be used to suit requirements. Indeed, transmission profiles may vary depending on a power requirement profile. Optionally, a transmission profile may be determined and implemented in order to reduce power wastage by the power supply.

### Transmission Controller

The transmission controller 210 may be able to instruct the driver 230 to selectively connect the power supply 240 to the primary inductor 220. The driver 230 may therefore provide power intermittently to the primary inductor 220. The intermittent power supply may oscillate between two states: an OFF state, during which no power is transmitted, and an ON state, during which power is transmitted at a constant power rate, for example full power. Typically, the level of power transmitted during the ON states remains constant although, where required the ON state may support a plurality of power settings.

Additionally or alternatively, the transmission controller 210 may be configured to receive data from the reception circuit 330, e.g., via a signal transfer system 400. Such data may communicate information relating to, e.g., a power requirement profile of the electric load 340 and the power storage element 332. The transmission profile may be variously selected by calculation, by reference to a look up table (e.g., of a pre-set list of power profiles) or the like based on the power requirement profile received. For example a transmission profile may be calculated from a power function, for example, by means of a computer or microprocessor running an appropriate algorithm. Optionally, the transmission profile may be calculated by any one of the transmission controller 210, the driver 230 or the reception circuit 330 or by any combination thereof. It is noted that one or more processors may be incorporated in the transmission controller 210, the driver 230, the reception circuit 330, the electrical load 340, the power storage element 332, or any connected element.

### Reception Circuit

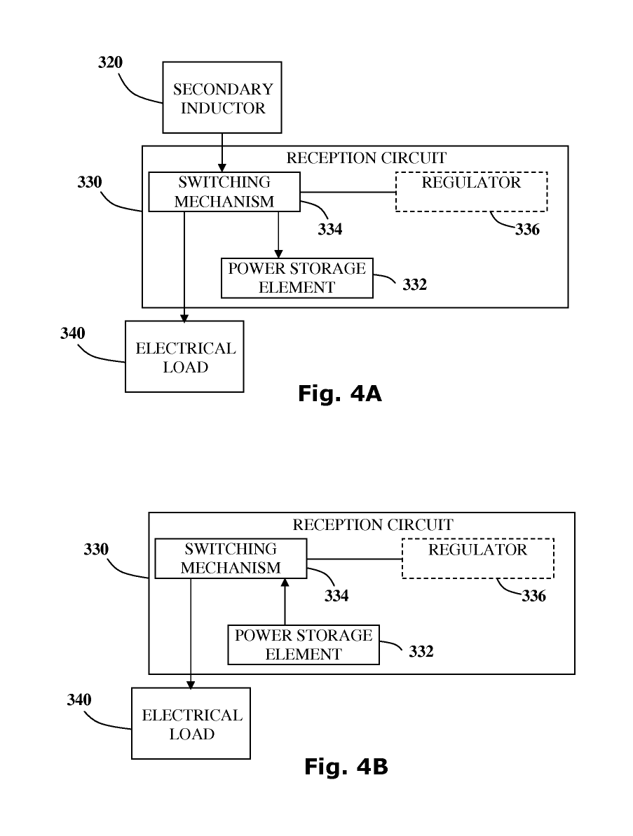

Reference is now made to the block diagrams of FIGS. 4A and 4B showing various configurations of the reception circuit 330. The reception circuit 330 may include a power storage element 332 and a switching mechanism 334. The power storage element may be provided to store excess power during the ON transmission state and to provide power to the electric load 340 during the OFF transmission state. It is noted that the reception circuit may additionally include various power control elements, such as rectifiers, switching units, ancillary loads such as resistors, capacitors, other coil-to-coil communication elements and the like.

With particular reference now to FIG. 4A, the transfer of power to the electrical load 340 and the power storage element 332 is represented during the ON transmission state (only the relevant portions of the inductive power transfer system 100 is provided for clarity). The driver 230 drives the primary inductor 220 at full power such that the secondary inductor 320 provides full power to the reception circuit 330. The switching mechanism 334 is operable to switch power to the electrical load 340, the power storage element 332 or both.

The relative portions of power from the secondary inductor 320 being directed to the electrical load 340 or the power storage element 332 may be based on the power requirement of the electrical load 340. Where full power is required by the electrical load 340, all power received by the secondary inductor 320 from the inductive power outlet 200 (not shown) may be directed to the electric load 340, by, e.g., the switching mechanism 334. Optionally, the switching mechanism 334 may direct a small portion of the power to the power storage element 332 for providing power to the reception circuit 330. Where a lower power level is required by the electrical load 340, the switching mechanism 334 may direct a reduced portion of the power received by the secondary inductor 320 to the electric load 340, as required, with the remaining portion of the power directed to the power storage element 332.

Referring now to the block diagram of FIG. 4B, the transfer of power to the electrical load 340 from the power storage element 332 during the OFF transmission state is represented (only the relevant portions of the inductive power transfer system 100 is provided for clarity). During the OFF transmission state, the driver 230 disconnects the primary inductor 220 from the power supply 240 such that no power is transmitted to the secondary inductor 320 and no power is received by the reception circuit 330 (as represented by the absence of the secondary inductor 320 in FIG. 4B). The switching mechanism 334 may be operable, during the OFF transmission state, to connect the electrical load 340 to the power storage element 332 such that the electrical load 340 draws the required power level from the power storage element 332, such that the electrical load 340 may receive the required level of power in a stable, uninterrupted manner, despite repeated changes in the transmission between ON and OFF.

The reception circuit 330 may further include a regulator 336 for regulating power transfer. By way of example, the reception circuit 330 may regulate the transfer of power, amongst others, in the following ways:
The reception circuit 330 may regulate the duration of the charging of the power storage element 332;
The reception circuit 330 may regulate the rate of power transfer to the power storage element 332;
The reception circuit 330 may regulate the power level of power transfer to the power storage element 332.
The reception circuit 330 may regulate the duration of the power transfer to the electrical load 340;
The reception circuit 330 may regulate the rate of power transfer to the electrical load 340;
The reception circuit 330 may regulate the power level of power transfer to the electrical load 340.

It is noted that the duration, rate and power level of power transfer from the reception circuit 330 to the electrical load 340 may be determined in part by the power requirement profile. As such, the power requirement profile may be determined by reference to a look up table or some other selection algorithm, or by calculation based on said reference, measured functional parameters of the electrical load, or a combination thereof.

The reception circuit 330 may use the power requirement profile of the electric load 340 to determine the rate of power transfer from the power storage device 332 to the electrical load 340. Additionally or alternatively, a processor associated with the reception circuit 330 may determine how much power is transferred to both the electrical load 340 and power storage element 332.

The reception circuit 330 may be configured to instruct the transmission controller 210 to switch between the ON and OFF transmission states as required, through a communication means, e.g., the signal transfer system 400. Accordingly, the transmission controller 210 may connect or disconnect the primary inductor 220 from the power supply 240 by instructing the driver 230.

In another example, the reception circuit 330 may be configured to receive data communicated by the electrical load 340 and the power storage element 332. The data may relate to the power requirement of each device or element. The power requirement profile may be calculated by means of a microprocessor and an algorithm, for example. The microprocessor and algorithm may be installed in the reception circuit 330, in the electrical load 340, in the power storage element 332 or in any connected device.

### Power Storage Element

Various power storage elements are known by those in the art and may be used in embodiments of the system described herein. For example, the power storage element 332 may be an electrochemical cell, a fuel cell, a capacitor, a supercapacitor, a battery of cells or the like. Other examples will occur to the skilled practitioner.

It is noted that, amongst others, the power storage element 332 may have the following attributes:

A power storage element 332 may be integrated in the reception circuit 330.

The power storage element 332 may be charged by the secondary coil 310.

The power storage element 332 may be able to provide power either to the reception circuit 330, to the electrical load 340, or both.

The power storage element 332 may be able to regulate the amount of power and the rate of power transfer to said reception circuit 330 and said electrical load 340.

### Signal Transfer System

Referring back to FIG. 2, the signal transfer system 400 may provide a channel (or alternatively a communication route) for passing communication signals between the inductive power outlet 200 and the inductive power receiver 300. The signal transfer system 400 may enable the transfer of data between one or more of the components associated with the inductive power outlet 200 (e.g., the transmission controller 210, the primary inductor 220 and the driver 230) and one or more of the components associated with the inductive power receiver (e.g., the secondary inductor 320, the electrical load 340, the reception circuit 330, the power storage element 332, the switching mechanisms 334, the regulator 336).

In one example, the signal transfer system may enable the transfer of data between the transmission controller 210 and the reception circuit 330. Further, the signal transfer system 400 may provide, via the reception circuit 330, a channel (or a communication route) for passing signals between the electrical load 340 or the power storage element 332 and the reception circuit 330. The communication signals may perform a variety of functions such as, inter alia, regulating power transfer or for communicating required power transmission parameters. Communications of required power transmission parameters may be particularly useful in systems where the power requirements vary depending on electrical load 340 usage or upon charge level of the electrochemical cell of the electrical load 340. Various signal transfer systems may be used such as conductive, optical, inductive, audio, ultrasonic signal emitters or the like in combination with appropriate detectors.

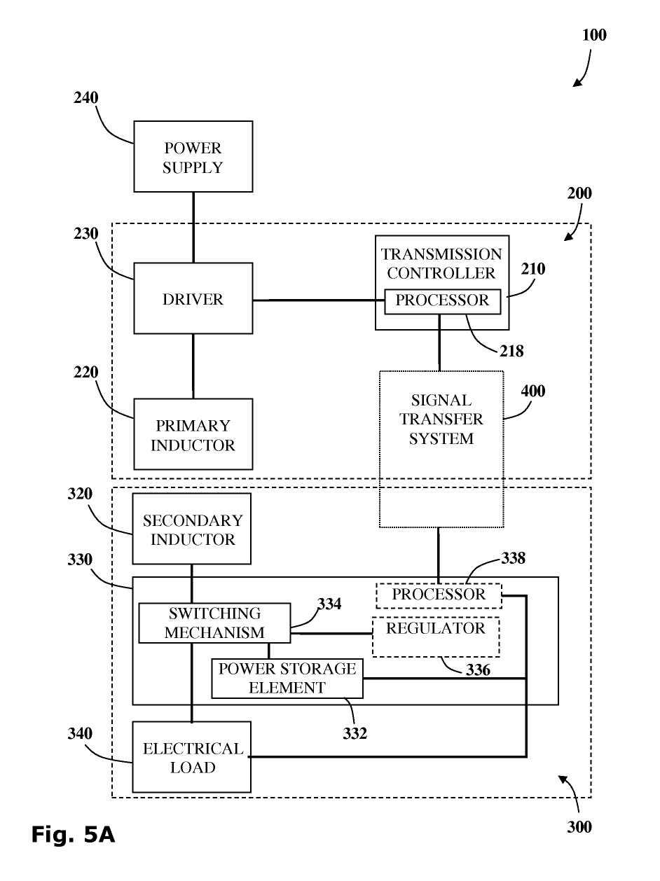

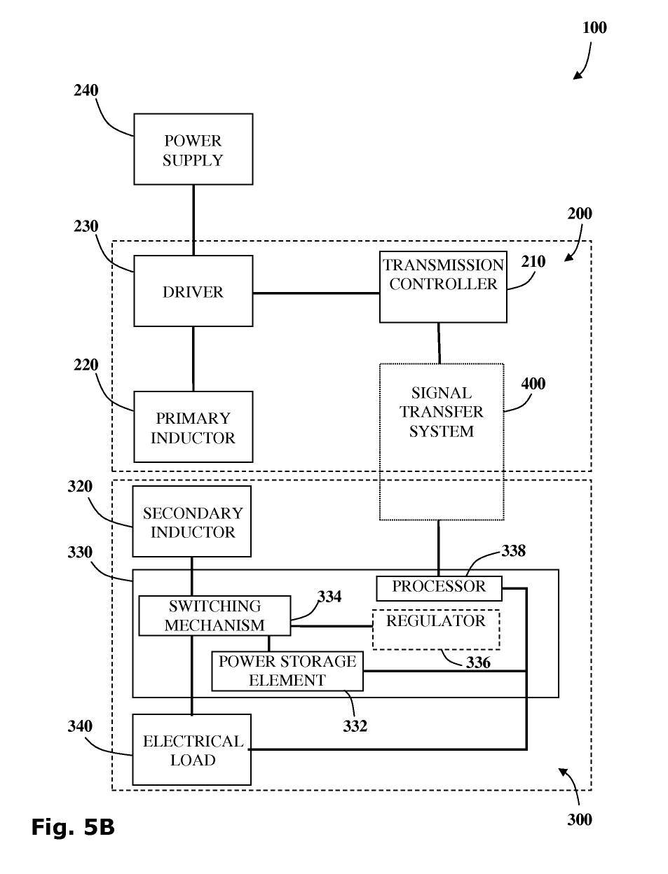

The block diagram of FIG. 5A represents one embodiment of how data may be transferred to the reception circuit 330 from the electrical load 340 and the power storage element 332, and then to the transmission controller 210. The data may be informative (e.g., power requirement or power requirement profile) or instructive (e.g., power transmission profile).

The reception circuit 330 may receive informative data from the electrical load 340 and/or the power storage element 332, e.g., their power requirements and statuses. The reception circuit 330 may use a microprocessor 338 running an algorithm to calculate (or selected from a pre-set list) a power requirement profile. The power requirement profile may reflect the power requirement of, e.g., the electrical load 340, the power storage element 332, or both. The reception circuit 330 may communicate one or more power requirement profiles to the transmission controller 210 through the signal transfer system 400. The transmission controller 210 may then use a microprocessor 218 running an algorithm to process the informative data (e.g. the power requirement profiles) received from the reception circuit 330 and generate or selected from a pre-set list instructive data (e.g., a transmission profile as described above) for driver 230 to e.g., set the periodicity and other parameters of the intermittent power supply, such as the duration of the ON transmission state or the duration of the OFF transmission state. Alternatively, the reception circuit 330 may transmit the power requirement of, e.g., the electrical load 340, the power storage element 332, or both to the microprocessor 28 running an algorithm to process the power requirement(s) to generate instructive data, e.g., the transmission profile. The transmission controller 210 may, based on the instructive data, select the ON transmission state or the OFF transmission state of the driver 230.

The block diagram of FIG. 5B represents another embodiment of how data may be transferred to the reception circuit 330 from the electrical load 340 and the power storage element 332, and then to the transmission controller 210.

The reception circuit 330 may receive informative data from the electrical load 340 and the power storage element 332, e.g., their power requirements and statuses. The reception circuit 330 may use a processor 338 and an algorithm to calculate (or selected from a pre-set list) a power requirement profile, and then further to generate (or selected from a pre-set list) instructive data e.g., a power transmission profile, to set the periodicity and other parameters of the intermittent power supply, such as the duration of the ON transmission state or the duration of the OFF transmission state. Alternatively, the reception circuit 330 may use the processor 338 and an algorithm to calculate (or select from a pre-set list) the instructive data, e.g., the power transmission profile, from the power requirement of, e.g., the electrical load 340, the power storage element 332, or both. The reception circuit 330 may then transfer the instructive data to the transmission controller 210 through the signal transfer system 440. The transmission controller 210 may, based on the instructive data, select the ON transmission state or the OFF transmission state of the driver 230.

The signal transfer system may transmit, from the reception circuit 330 to the transmission controller 210, one or more of the following: power requirement, power requirement profile, the transmission profile, power transmission instructions or the like. The power requirement may be that of e.g., the electrical load 340, the power storage element 332, or both. The power requirement profile may be that of e.g., the electrical load 340, the power storage element 332, or both.

### Method for Intermittent Power Supply

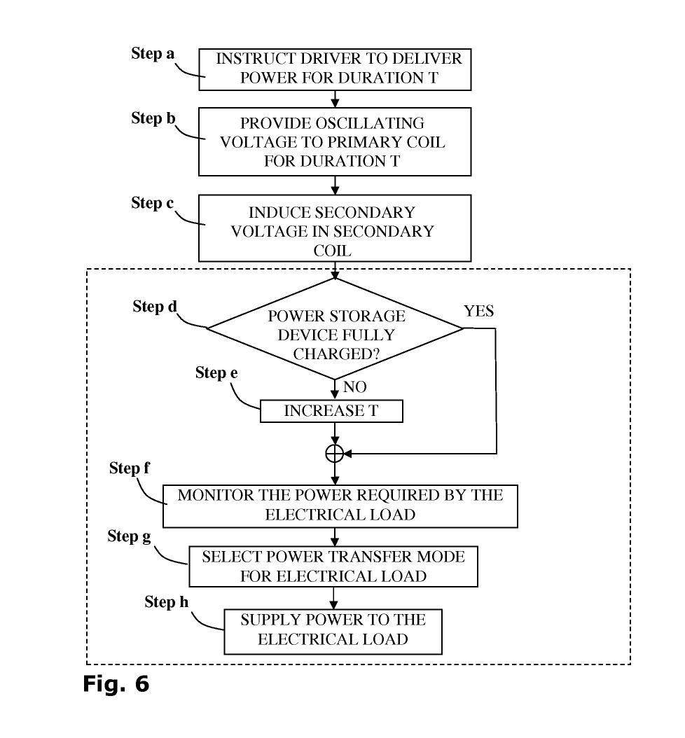

With reference to the flowchart of FIG. 6 and by means of an example, we now describe a method by which how embodiments such as described hereinabove may operate alone or in combination to control an intermittent power supply to the electrical load 340 and the power storage element 332.

An electrical load 340, for example, a mobile device powered by a rechargeable battery 302, such as a mobile phone 342, a computer or the like, may receive power from the inductive power supply 100 (FIG. 1A, 2). The electrical load 340 may be directly attached to elements in the reception circuit 330 (FIG. 2). The electrical load 340 may be placed on the primary induction unit 200 (FIG. 1A). The electrical load 340 may require a power supply 240 to activate the mobile device 342 or to charge its rechargeable battery 302.

The reception circuit 330 may determine how much power is required to charge the battery 302 and how much power is required to power the mobile device 342 (FIG. 6, steps d-g). The reception circuit 330 may also determine how much power is required to charge the power storage element 332. The reception circuit 330 may use the data from these power requirements to determine the power requirement profile of the electrical load 340 and the power storage element 332 (FIG. 6, step g). The power requirement profile of the electrical load 340 and the power storage element 332 may be updated by the reception circuit 330. Power requirement profile updating may occur at any time while the mobile device 342 is attached to the reception circuit 330. The power requirement profile may be updated immediately prior to switching of the power transmission to the ON state.

The reception circuit 330 may use the power requirement profile to determine the duration for which the power transmission will be set to the ON state (FIG. 6, step a). The reception circuit 330 may instruct the driver 230 to switch the power transmission to the ON state for duration T (FIG. 6, step b-c). The reception circuit 330 may instruct the driver 230 to switch the power transmission to the OFF state, once the required duration in the ON state has transpired.

When the power transmission is in the ON state, the electrical load 340 may receive power from the reception circuit 330, as determined by the power requirement profile (FIG. 6, steps g,h). In addition, the power storage element 332 may receive power from the reception circuit 330, as determined by the power requirement profile (FIG. 6, step g) and as executed by the switching mechanism 334.

When the power transmission is switched to the OFF state, the reception circuit 330 may transfer power from the power storage element 332 to the electrical load 340 (FIG. 6, step g). The power transferred to the electrical load 340 may be used to activate the mobile device 342 or to recharge its battery 302 (FIG. 6, step h). The duration of the OFF state may be determined by the reception circuit 330 (FIG. 6, step d-f). The duration of the OFF state may allow for efficient transfer of power from the power storage element 332 to the electrical load 340 (FIG. 6, steps g,h).

The reception circuit 330 may recalculate the power requirement profiles of the electrical load 340 and the power storage element 342 upon transpire of the OFF state of the power supply 340 (FIG. 6, steps d-f). The reception circuit 330 may then determine anew the duration of the ON state T of the power supply 240 (FIG. 6, step a). The reception circuit 330 may also determine anew the duration of the OFF state of the power supply 340.

It will be apparent from the above description that various embodiment of the present disclosure disclose significant advantages enabling the energy efficient inductive transfer of power. It is further noted that, in combination, these advantages allow an inductive power transmission system to become a practical tool suitable for a variety of applications.

The scope of the present disclosure is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An inductive power transfer system comprising a primary inductor wired to a transmission controller and a power supply via a driver, and operable to inductively couple with a secondary inductor wired to an electric load via a reception circuit, wherein:
said transmission controller instructs the driver to apply an oscillating driving voltage to said primary inductor in an intermittent pattern comprising an alternation of the driver being in an ON state and an OFF state, characterized by a transmission requirement profile; and
said reception circuit comprises at least one power storage element configured:
to store power received by said secondary inductor when said driving voltage is applied; and
to provide power to said electric load.

2. The system of claim 1, wherein the level of power transmission during the ON state is constant.

3. The system of claim 2, wherein the level of power transmission during the ON state is at full power.

4. The system of claim 1, wherein said transmission profile is determined in accordance with a power requirement profile.

5. The system of claim 4 wherein said power requirement profile is determined according to the power requirement of the electric load.

6. The system of claim 5 wherein said power requirement profile is determined further according to the power requirement of the power storage element.

7. The system of claim 4, wherein the transmission profile is selected from a pre-set list.

8. The system of claim 5, wherein the power requirement profile is selected from a pre-set list.

9. The system of claim 1 wherein said reception circuit further comprises a switching mechanism configured to direct a first portion of the power received by the secondary inductor to the electric load and to direct a second portion of the power received by the secondary inductor to the power storage element 332.

10. The system of claim 9 wherein the first portion of the power received by the secondary inductor and the second portion of the power received by the secondary inductor is selected according to the power requirement of the electrical load.

11. The system of claim 9 wherein said switching mechanism is further operable to connect said power storage element to said electric load, such that power is transferred from the power storage element to the electric load.

12. The system of claim 9 wherein the switching mechanism is operable to connect said power storage element to said electric load when the driver is in the OFF state.

13. The system of claim 12, wherein said switching element is operable to provide a constant level of power to the electric load despite the alternation of the driver between the ON state and the OFF state.

14. The system of claim 1 wherein said power storage element comprises a capacitor.

15. The system of claim 1 wherein said power storage element comprises an electrochemical cell.

16. A method for providing inductive power from an electric load via a primary inductor wired to a transmission controller and a secondary inductor wired to the electric load, the method comprising:
providing a power storage element selectably connectable to said secondary inductor and the electrical load;
determining a transmission profile having ON states and OFF states of duration selected to provide power at a required rate;
driving said primary inductor at full power during the ON states as according to said transmission profile;
storing, in the power storage element, excess power delivered during the ON states; and
delivering power from the power storage element to said load during the OFF states.

17. The method of claim 16, wherein the transmission profile is determined according to a power requirement profile.

18. The method of claim 17, wherein the power requirement profile is determined according to the power requirement of the electrical load.

19. The system of claim 18 wherein said power requirement profile is determined further according to the power requirement of the power storage element.

20. The system of claim 16, wherein the transmission profile is selected from a pre-set list.

21. The system of claim 17, wherein the power requirement profile is selected from a pre-set list.

22. The system of claim 1 wherein the level of power transmission during the ON state is selected such that the inductive power transfer system transfers power with a high efficiency.

23. The system of claim 1 wherein said inductive power transfer is configured to have a power transfer efficiency peak at the power level at which the system operates during the ON state.
